(19) United States
(12) Patent Application Publication
(10) Pub. No.: US 2010/0170496 A1
(43) Pub. Date: Jul. 8, 2010

(54) LIGHTING EFFECTS IN A HEATING APPLIANCE

(75) Inventors: Richard D. Berg, Lakeville, MN (US); Christopher L. Wurtz, Rochester, MN (US)

Correspondence Address: FAEGRE & BENSON LLP;PATENT DOCKETING - INTELLECTUAL PROPERTY (77012), 2200 WELLS FARGO CENTER, 90 SOUTH SEVENTH STREET, MINNEAPOLIS, MN, 55402-3901, US

(73) Assignee: HNI Technologies Inc., Muscatine, IA (US)

(21) Appl. No.: 12/349,548

(22) Filed: Jan. 7, 2009

(51) Int. Cl. F24B 1/191; B23P 19/04

(52) U.S. Cl. 126/512; 29/700

(57) ABSTRACT

A fireplace includes a first enclosure defining a combustion chamber and having a front that allows viewing within the combustion chamber, one or more back panels opposite the front, a plurality of side panels, a top panel, and a bottom panel. At least one of the one or more back panels and plurality of side panels includes a plurality of optically transmissive regions. A second enclosure includes a plurality of panels that are secured together to surround the plurality of side panels. A flame-generating element is disposed within the combustion chamber adjacent the bottom panel and is adapted to generate a flame. A lighting assembly between the first enclosure and the second enclosure is operable to project light onto portions of the second enclosure facing the first enclosure to passively illuminate an interior of the combustion chamber through the plurality of optically transmissive regions.

### BACKGROUND

Gas, electric, and wood burning fireplaces are an efficient method for providing warmth and creating the appeal of a fire within a room. Fireplaces have become commonplace in today's building trades for both residential and commercial applications. Most new home construction designs include at least one, and often several fireplaces. Further, a significant number of remodeling projects are focused on fireplaces. One concern is providing an appealing view of the fireplace contents. A lighting system for a fireplace provides light inside the fireplace to, for example, enhance the aesthetic appeal of the fireplace.

### SUMMARY

One aspect of the present invention relates to a fireplace including a lighting system for providing lighting effects in the fireplace. A first enclosure defining a combustion chamber has a front allowing viewing within the combustion chamber, one or more back panels opposite the front, a plurality of side panels, a top panel, and a bottom panel. At least one of the one or more back panels and plurality of side panels includes a plurality of optically transmissive regions. A second enclosure includes a plurality of panels that are secured together to surround the plurality of side panels. A flame-generating element is disposed within the combustion chamber adjacent the bottom panel and is adapted to generate a flame. A lighting assembly between the first enclosure and the second enclosure is operable to project light onto portions of the second enclosure facing the first enclosure to passively illuminate an interior of the combustion chamber through the plurality of optically transmissive regions.

In another aspect of the present invention, a fireplace includes an enclosure defining a combustion chamber and having a front allowing viewing within the combustion chamber, one or more back panels opposite the front, a plurality of side panels, a top panel, and a bottom panel. At least one of the one or more back panels and plurality of side panels includes a plurality of optically transmissive windows. A flame-generating element is positioned adjacent to the bottom panel, and a lighting assembly is operable to project light into the combustion chamber through the plurality of optically transmissive windows. A controller is configured to control operation of the lighting assembly.

In a further aspect of the present invention, a method for providing lighting effects in a fireplace includes providing a first enclosure adapted to function as a combustion chamber. The first enclosure includes a front allowing viewing within the combustion chamber, one or more back panels opposite the front, a plurality of side panels, and a bottom panel. At least one of the one or more back panels and plurality of side panels includes a plurality of optically transmissive windows. A second enclosure including a plurality of panels is secured together to surround the plurality of side panels. Light is projected between the first enclosure and second enclosure to passively illuminate an interior of the first enclosure through the plurality of optically transmissive windows.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a front plan view of an example fireplace in accordance with the present invention.

FIG. 2 a front perspective view of the fireplace shown in FIG. 1.

FIG. 3 is an exploded front perspective view of a portion of a combustion chamber including optically transmissive windows according to an embodiment of the present invention.

FIG. 4 is an exploded front perspective view of the fireplace shown in FIG. 1.

FIG. 5 is a cross-sectional view of the fireplace shown in FIG. 1 taken along cross-sectional indicators 5-5.

FIG. 6 is a cross-sectional view of the fireplace shown in FIG. 1 taken along cross-sectional indicators 6-6.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

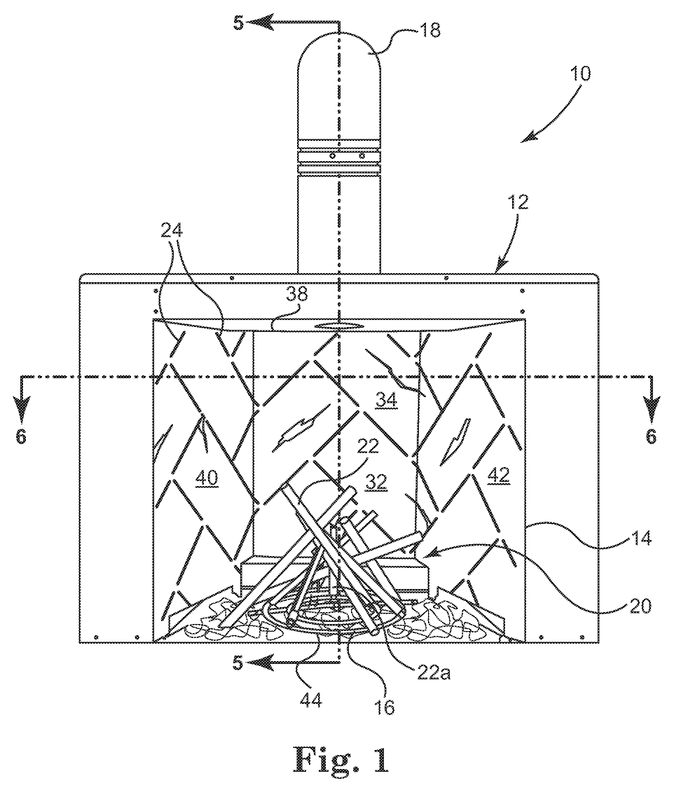

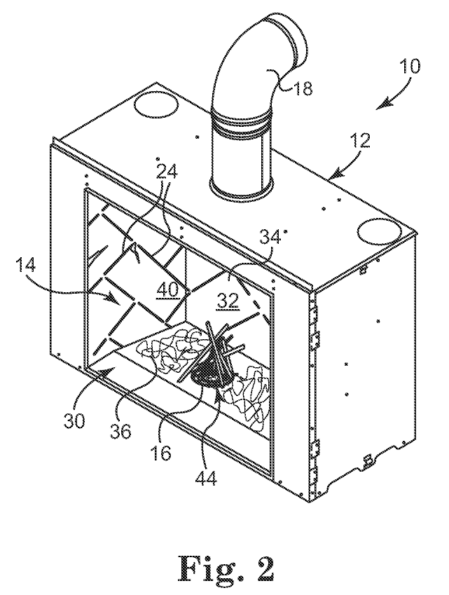

FIG. 1 is a front plan view and FIG. 2 is a front perspective view of fireplace assembly 10, including outer enclosure 12, combustion chamber enclosure 14, burner assembly 16, direct vent duct 18, and log set 20. Combustion chamber enclosure 14 includes front 30, back panel 32, bottom panel 36, top panel 38, and side panels 40 and 42. Front 30 may include a glass panel to allow viewing of the interior of combustion chamber enclosure 14. The arrangement of panels that comprise combustion chamber enclosure 14 are merely shown by way of example, and any arrangement of any number of panels may be connected to form combustion chamber enclosure 14. For example, while a single back panel 32 is shown, combustion chamber enclosure 14 may include two or more back panels disposed at non-zero angles with respect to each other.

Log set 20 is formed on and around burner assembly 16 and includes a plurality of rod-like elements 22 arranged in a teepee configuration. At least one of the rod-like elements 22 may form a part of burner assembly 16, such that rod-like elements 22 that are part of burner assembly 16 provide flame for fireplace assembly 10. In some embodiments, rod-like elements 22 are comprised of a metallic material such as steel or iron. In the embodiment shown, rod-like element 22a extends substantially vertically through the middle of burner assembly 16 and is connected to burner manifold 44. Burner manifold 44 provides a conduit between the main gas supply of fireplace assembly 10 and rod-like element 22. Consequently, rod-like element 22a is the primary flame source for fireplace assembly 10. Others of rod-like elements 22 that are arranged at an angle relative to rod-like element 22a may also carry combustible fuel that is ignited by the flame generated by rod-like element 22a. The fuel-carrying rod-like elements 22 may include a plurality of apertures that release the combustible fuel for ignition by the flame from rod-like element 22a. Additional rod-like elements 22 that do not carry fuel may be arranged around the fuel-carrying rod-like elements 22 to provide log set 20 as shown. Alternatively, log set 20 may be an arrangement of conventional synthetic logs, such as logs comprised of ceramic fibers or plastic. Fireplace assembly 10 may also include an arrangement of rocks or other elements (not shown) around burner assembly 16 and log set 20.

A plurality of optically transmissive windows 24 are formed in or on some or all of the panels of combustion chamber enclosure 14. More particularly, optically transmissive windows 24 are formed in or on back panel 32 and side panels 40 and 42. As will be described in more detail herein, optically transmissive windows 24 are passively illuminated to provide decorative lighting viewable through the front of combustion chamber enclosure 14. The pattern of optically transmissive regions 24 may be selected to provide particular lighting effects within combustion chamber enclosure 14 to improve the aesthetics of the fireplace. Qualities of the light projected through optically transmissive regions 24, such as color and/or intensity, may be modulated to further enhance the lighting effects.

In the embodiment shown, optically transmissive windows 24 are organized in a pattern that resembles an angled arrangement of bricks or blocks. That is, optically transmissive windows 24 are arranged to represent the grouted portions between adjacent bricks, while the refractory surrounding optically transmissive windows 24 represents the bricks. It will be appreciated that the pattern of optically transmissive windows 24 is merely provided by way of example, and any pattern or arrangement of optically transmissive windows 24 may be formed in combustion chamber enclosure 14. Example patterns that may be formed by optically transmissive windows 24 include, but are not limited to, stripes, polka dots, jagged slots, crosses, corporate logos, sports team logos, shapes of equal or varying sizes, and so on. In addition, symbols or characters may be formed in combustion chamber enclosure 14, such as letters or numbers, punctuation marks, or currency symbols such as a dollar sign. Furthermore, words or names may be spelled out by optically transmissive windows 24, such as the name of the user of fireplace assembly 10 or the name of the user's favorite sports team.

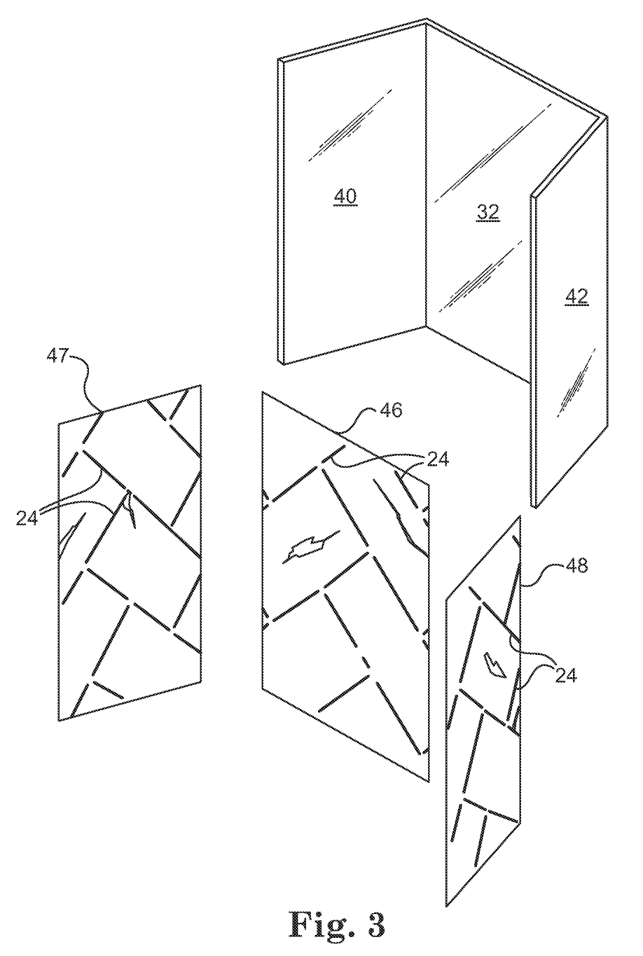

Optically transmissive windows 24 may be formed in or on combustion chamber enclosure 14 in a variety of ways. FIG. 3 is an exploded front perspective view of back panel 32, side panel 40, and side panel 42 of combustion chamber enclosure 14 with combustion chamber liners 46, 47, and 48 having optically transmissive windows 24 formed therein. In this embodiment, at least a portion of back panel 32, side panel 40 and/or side panel 42 of combustion chamber enclosure 14 are comprised of a transparent material. The transparent material may be a transparent heat-resistant material, such as ceramic glass. The transparent material of back panel 32, side panel 40, and side panel 42 may be sealingly attached together to form a portion of combustion chamber enclosure 14. Alternatively, sheets of the transparent material may be sealed or gasketed into large cutouts in combustion chamber enclosure 14. The transparent material may also be colored or uncolored.

Combustion chamber liners 46, 47, and 48 include a plurality of apertures that form a pattern of optically transmissive windows 24 through combustion chamber liners 46, 47, and 48. Combustion chamber liners 46, 47, and 48 are comprised of a heat resistant material, such as a high melting point metallic material. When assembled, combustion chamber liner 46 is secured to back panel 32, combustion chamber liner 47 is secured to side panel 40, and combustion chamber liner 48 is secured to side panel 42. Combustion chamber liners 46, 47, and 48 may be secured to back panel 32, side panel 40, and side panel 42, respectively, on the inside or the outside combustion chamber enclosure 14. In operation, light is projected indirectly toward back panel 32 and side panels 40 and 42, and the indirect light passes through optically transmissive windows 24 such that the pattern defined by optically transmissive windows 24 is passively illuminated and viewable through the front of combustion chamber enclosure 14.

In an alternative embodiment, a pattern of apertures is cut into back panel 32, side panel 40, and side panel 42 of combustion chamber enclosure 14, and transparent or translucent heat-resistant glass (e.g., ceramic glass) is sealed or gasketed into the apertures. In essence, any type of refractory (i.e., high melting point material) including optically transmissive windows 24 may be employed to allow light to pass through portions of the panels of combustion chamber enclosure 14. In addition, while optically transmissive windows 24 are shown formed on back panel 32 and side panels 40 and 42, it will be appreciated that the optically transmissive windows 24 can be formed in or on any of the panels that form combustion chamber enclosure 14.

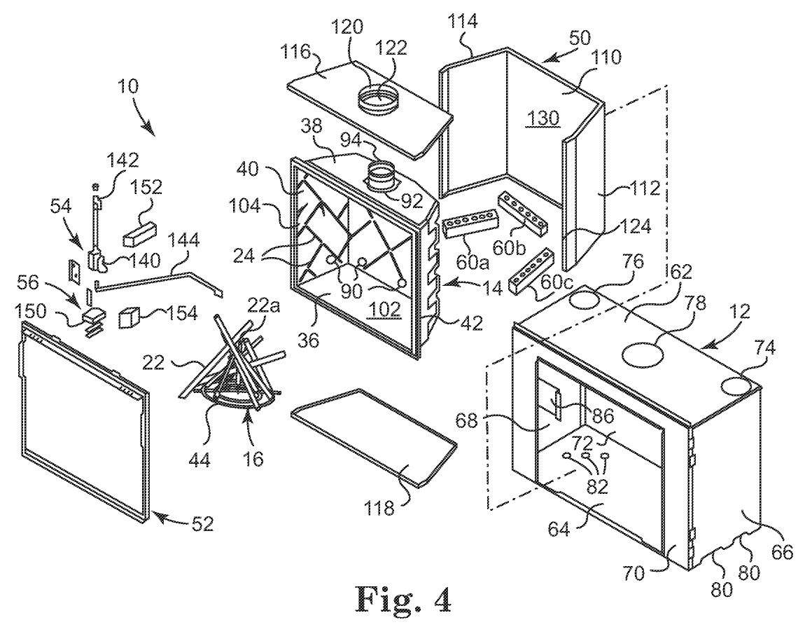

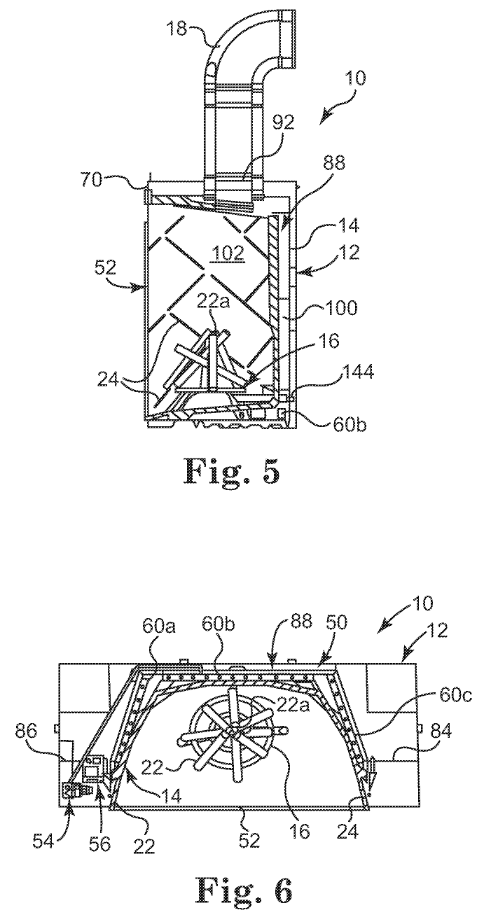

FIG. 4 is an exploded front perspective view of the fireplace shown in FIG. 1, FIG. 5 is a cross-sectional view of the fireplace shown in FIG. 1 taken along cross-sectional indicators 5-5, and FIG. 6 is a cross-sectional view of the fireplace shown in FIG. 1 taken along cross-sectional indicators 6-6. As shown in these figures, fireplace assembly 10 further includes combustion air enclosure 50, glass panel 52, gas valve assembly 54, control unit assembly 56, and lighting assemblies 60a, 60b, and 60c.

Outer enclosure 12 includes a plurality of panels secured together to form a box-like structure sized to receive and/or mount the features listed above. The panels of outer enclosure 12 include top panel 62, bottom panel 64, first side panel 66, second side panel 68, front panel 70, and rear panel 72. Panels 62, 64, 66, 68, 70, and 72 may be secured together by any of a variety of methods including, for example, welding, using fasteners, or formed using such techniques as bending or stamping several panels from a single piece of material. Outer enclosure 12 may also include convection air outlets 74 and 76 that allow air that has been heated within the outer enclosure to exit out from outer enclosure 12, for example, using a pump or fan and then directing the heated air to and air space to be heated or to a furnace ducting system (not shown).

Outer enclosure 12 also includes vent outlet 78 for receiving exhaust duct 18 through top panel 62. A bottom edge of side panels 66 and 68 and/or rear panel 72 may include air escapes 80. Bottom panel 64 may include air escapes 82 into the space within the outer enclosure 12 adjacent to combustion chamber enclosure 14 to facilitate air flow out from under bottom panel 64 to reduce heat buildup under outer enclosure 12.

Front panel 70 is preferably configured for mounting a decorative covering such as, for example, a fireplace surround, brick, stone, or tile, after fireplace assembly 10 is installed.

Outer enclosure 12 may also include combustion air enclosure support 84 secured to side panel 66 and combustion air enclosure support 86 secured to side panels 68. Supports 84 and 86 may be coupled to side panels (discussed below) of the combustion air enclosure 50 to stabilize firebox 88 (including combustion chamber enclosure 14 and combustion air enclosure 50) during transport and use of fireplace assembly 10. Supports 84 and 86 may be supplemented with additional supports (not shown) and may be positioned at different locations within outer enclosure 12 to optimize support and stability of firebox 88 within outer enclosure 12.

Combustion chamber enclosure 14 may also include a plurality of combustion air inlet openings 90, and exhaust opening 92 to which an exhaust collar 94 may be secured to vent combustion gases out of the combustion chamber enclosure 14. The combustion air inlet openings 90 provide air pathways between a combustion air chamber 100 (discussed below) defined by the combustion air enclosure 50 and the combustion chamber enclosure 14 to provide combustion air for burning the fuel within the combustion chamber enclosure 14.

Combustion chamber enclosure 14 may be formed using, for example, a molding process that uses a ceramic material (such as moldable ceramic or a ceramic fiber) with a binder (see U.S. Pat. No. 7,098,269, which is incorporated by reference), or a stamping or other forming method for shaping a metal sheet. An advantage of using a molding process is that the various panels of combustion chamber enclosure 14 may be formed in a single step (for example using an injection, compression, or vacuum molding process), and the shape and size of pattern or design on panels 32, 34, 36, 38, 40, and 42 are consistent from panel to panel. In addition, the size and shape of the apertures for optically transmissive windows 24 can be precisely and accurately formed into panels 32, 34, 40, and/or 42 in a molding process. This provides a tight seal between combustion chamber enclosure 14 and combustion air enclosure 50 when optically transmissive windows 24 are sealed in the apertures. Using a steel product that is stamped or otherwise formed with the desired pattern or design may have the advantage of lower cost and lighter weight as compared to a molded ceramic.

Panels 32, 34, 36, 38, 40, and 42 of combustion chamber enclosure 14 define combustion chamber 102. Front surface 104 of combustion chamber enclosure 14 is sized and configured to mount glass panel 52 and provide a surface for creating an airtight seal between glass panel 52, combustion air enclosure 50, and combustion chamber enclosure 14.

Combustion air enclosure 50 includes a plurality of panels, which when assembled together and secured to the combustion chamber enclosure 14 provide combustion air chamber 100. Combustion air enclosure 50 includes rear panel 110, first side panel 112, second side panel 114, top panel 116 and bottom panel 118. Rear panel 110 and side panels 112 and 114 may be formed from a single piece of material that is bent or otherwise formed to provide the various panels. Alternatively, rear panel 110 and side panels 112 and 114 may be separately formed and secured together and later secured to top panel 116 and bottom panel 118 with welding, fasteners, or other suitable connection methods. In some embodiments, panels 110, 112, 114, 116, and 118 of combustion air enclosure are molded from ceramic material.

Combustion air collar 120 defining combustion air opening 122 may be formed or otherwise secured in top panel 116 or another panel of combustion air enclosure 50 so as to provide a source of combustion air into combustion air chamber 100. In this example embodiment, fireplace assembly 10 includes coaxial pipe 18 that facilitates combustion airflow through an outer pipe and exhaust airflow through a center exhaust pipe of coaxial pipe 18.

Combustion air enclosure 50 is secured to combustion chamber enclosure 14 along front surface 104 of combustion chamber enclosure 14 and front surface 124 of combustion air enclosure 50 such that a gasket or other sealing structure can be used to form an airtight seal between enclosures 14 and 18. The combined combustion chamber enclosure 14 and combustion air enclosure 50 form firebox assembly 88.

Combustion air enclosure 50 is configured so as to provide a jacket or wrap around the outer surface of combustion chamber enclosure 14 (except around the front surface 104), thus providing combustion air chamber 100 that facilitates free flow of combustion air around panels 32, 34, 36, 38, 40, and 42 of combustion chamber enclosure 14. As a result of this configuration, a hole extending through any panel of combustion chamber enclosure 14 provides an opening for intake of combustion air into combustion chamber enclosure 14. Thus, combustion air can be provided at very specific locations within combustion chamber enclosure 14 to meet the specific needs of a particular burner assembly design. Also, when using a plurality of combustion air inlet openings 90 throughout combustion chamber enclosure 14, fireplace assembly 10 is much less susceptible to environmental changes such as, e.g., high gusts of wind that would otherwise extinguish the fire within combustion chamber enclosure 14. Furthermore, the movement of combustion air around the outer surface of combustion chamber enclosure 14 helps to cool combustion chamber enclosure 14 and provide a further insulating layer between combustion chamber enclosure 14 and outer enclosure 12.

Gas valve assembly 54 includes valve 140, gas inlet supply 142, and gas burner supply 144. Controller 56 includes control module 150, electrical junction box 152, and remote control sensor 154. Gas valve assembly 54 and controller 56 may be generally referred to as “controls” for fireplace assembly 10. Other example features of fireplace assembly 10 that may also be considered part of the fireplace controls are switches, dials, computer chips and microprocessors, sensors, wiring, and meters. These controls may be used to control accessories associated with the fireplace, such as, for example, lights, blowers (e.g., circulating fan), artificial displays, sounds, etc. In some embodiments, some or all of the fireplace controls may be positioned outside of outer enclosure 12, or may be positioned under firebox 88 either inside or outside of outer enclosure 12.

Lighting assemblies 60a, 60b, and 60c are disposed between combustion chamber enclosure 14 and combustion air enclosure 50. In the embodiment shown, lighting assemblies 60a, 60b, and 60c are arranged proximate bottom panel 36 of combustion chamber enclosure 14 and bottom panel 118 of combustion air enclosure 50. This location allows easy accessibility to lighting assemblies 60a, 60b, and 60c in the event of a malfunction. In addition, locating lighting assemblies 60a, 60b, and 60c near bottom panel 36 and bottom panel 118 minimizes the effect of heat from combustion chamber enclosure 14 on lighting assemblies 60a, 60b, and 60c. In particular, this location for lighting assemblies 60a, 60b, and 60c is below burner assembly 16 and spaced apart from combustion chamber enclosure 14, which minimizes exposure of lighting assemblies 60a, 60b, and 60c to the heat generated by combustion chamber enclosure 14. Lighting assemblies 60a-60c may alternatively be arranged in other areas between combustion chamber enclosure 14 and combustion air enclosure 50, such as proximate top panel 116 of combustion air enclosure 18.

Lighting assemblies 60a, 60b, and 60c project light upwardly between combustion chamber enclosure 14 and combustion air enclosure 50. The projected light reflects from panels 110, 112, 114, 116, and 118 of combustion air enclosure 50 toward optically transmissive windows 24 to passively illuminate combustion chamber 102. In other words, a substantial amount of illumination through optically transmissive windows 24 is indirect. In order to maximize the amount of light that is reflected from combustion air enclosure 50, front face 130 of combustion air enclosure 50, which faces combustion chamber enclosure 14 and is defined by panels 110, 112, and 114, may be coated with a high reflectivity material. In one embodiment, combustion air enclosure 50 is coated with a high temperature resistant flat white paint. In an alternative embodiment, lighting assemblies 60a-60c are arranged to illuminate combustion chamber 102 directly through optically transmissive windows 24.

Lighting assemblies 60a, 60b, and 60c may include any type of light capable of producing sufficient light to passively illuminate combustion chamber 102 through optically transmissive windows 24. In one embodiment, each lighting assembly 60a-60c includes a plurality of light emitting diodes (LEDs). The LEDs may be arranged in a bar configuration as shown in FIGS. 3-5. Alternatively, individual LEDs may be assembled between combustion chamber enclosure 14 and combustion air enclosure 50 to provide a desired lighting effect.

Lighting assemblies 60a-60c may be configured to vary the color and/or intensity of the light projected. For example, lighting assemblies 60a-60c may be configured to vary the color of the projected light periodically, or the lights may be configured to change between colors with a smooth transition or no transition. Lighting assemblies 60a-60c may also be connected to controller 56 to provide additional lighting control and effect options. For example, controller 56 may be configured to vary the color and/or intensity of the projected light in response to an input. In one embodiment, the color and/or intensity of the projected light varies in response to an acoustic input, such as music or ambient sound around fireplace assembly 10. The acoustic input may be received by a microphone associated with controller 56, or from a home audio system connected to controller 56, for example. In another embodiment, the color and/or intensity of the projected light varies in response to a user input on a remote control sensed by remote control sensor 154.

It will be appreciated that while the present invention has been described in connection with a particular configuration of gas fireplace, the lighting system of the present invention may also be applied to other types of prefabricated gas fireplaces including, but not limited to, direct vent, universal vent, B-vent, horizontal/vertical-vent, dual direct vent, or a multisided unit. The present invention may also be applicable to other combustible gas fireplace systems, as well as any other types of fireplaces, such as a simulated electric fireplace or a solid fuel burning fireplace.

As understood from the foregoing, some aspects of the present invention relate to a fireplace including a lighting system for providing lighting effects in the fireplace. The fireplace includes a first enclosure defining a combustion chamber and having a front that allows viewing within the combustion chamber. The first enclosure also includes one or more back panels opposite the front, a plurality of side panels, a top panel, and a bottom panel. At least one of the one or more back panels and plurality of side panels includes a plurality of optically transmissive regions. A second enclosure includes a plurality of panels that are secured together to surround the plurality of side panels. A flame-generating element is disposed within the combustion chamber adjacent the bottom panel and is adapted to generate a flame. A lighting assembly between the first enclosure and the second enclosure is operable to project light onto portions of the second enclosure facing the first enclosure to passively illuminate an interior of the combustion chamber through the plurality of optically transmissive regions. The pattern of the optically transmissive regions may be selected to provide particular lighting effects in the combustion chamber to enhance the aesthetics of the fireplace. The lighting assembly may also optionally project light in various colors and/or at various intensities to create visually attractive lighting effects.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A fireplace comprising:
a first enclosure defining a combustion chamber and having an open front to allow viewing within the combustion chamber, one or more back panels opposite the open front, a plurality of side panels, a top panel, and a bottom panel, wherein at least one of the one or more back panels and plurality of side panels includes a plurality of optically transmissive regions;
a second enclosure including a plurality of panels secured together around the first enclosure;
a flame-generating element disposed within the combustion chamber and adapted to generate a flame, the flame-generating element being positioned adjacent the bottom panel of the combustion chamber enclosure; and
a lighting assembly between the first enclosure and the second enclosure operable to project light onto portions of the second enclosure that face the first enclosure to passively illuminate the combustion chamber through the plurality of optically transmissive regions.

2. The fireplace of claim 1, wherein portions of the plurality of second panels facing the combustion chamber include a reflective coating.

3. The fireplace of claim 1, wherein the lighting assembly is disposed proximate the bottom panel of the combustion chamber and arranged to project light upwardly between the first enclosure and the second enclosure.

4. The fireplace of claim 1, wherein the lighting assembly comprises a plurality of light emitting diodes (LEDs).

5. The fireplace of claim 1, wherein the lighting assembly is operable to vary a color of the light projected onto the second enclosure.

6. The fireplace of claim 1, wherein the plurality of optically transmissive regions comprises windows of heat-resistant glass.

7. The fireplace of claim 1, wherein the plurality of optically transmissive regions are arranged in a pattern on the at least one of the one or more back panels and the plurality of side panels.

8. The fireplace of claim 1, wherein the first enclosure and the second enclosure define a combustion air enclosure therebetween.

9. The fireplace of claim 1, and further comprising:
a log set comprising a plurality of metallic rods, wherein at least one of the plurality of metallic rods forms a portion of the flame-generating element.

10. The fireplace of claim 1, wherein the at least one of the one or more back panels and plurality of side panels comprises a first layer comprised of a transparent material and a second layer comprised of an opaque material and including a plurality of apertures formed therein.

11. A fireplace comprising:
an enclosure defining a combustion chamber and having a front allowing viewing within the combustion chamber, one or more back panels opposite the front, a plurality of side panels, a top panel, and a bottom panel, wherein at least one of the one or more back panels and plurality of side panels includes a plurality of optically transmissive windows;
a flame-generating element positioned adjacent to the bottom panel;
a lighting assembly arranged to passively illuminate the combustion chamber through the optically transmissive windows; and
a controller configured to control operation of the lighting assembly.

12. The fireplace of claim 11, wherein the lighting assembly is disposed proximate the bottom panel of the combustion chamber and arranged to project light upwardly toward the plurality of optically transmissive windows.

13. The fireplace of claim 11, wherein a combustion air enclosure surrounds the combustion chamber, and wherein the lighting assembly projects light onto portions of the combustion air enclosure that face the combustion chamber to passively illuminate the combustion chamber through the optically transmissive windows.

14. The fireplace of claim 13, wherein the portions of the combustion air enclosure that face the combustion chamber are coated with a reflective coating.

15. The fireplace of claim 11, wherein the controller is operable to vary a color of the light projected by the lighting assembly.

16. The fireplace of claim 11, wherein the controller is operable to vary at least one of a color and intensity of the light projected by the lighting assembly in response to an input.

17. The fireplace of claim 11, wherein the optically transmissive windows comprise ceramic glass.

18. A method for providing lighting effects in a fireplace, the method comprising:
providing a first enclosure adapted to function as a combustion chamber and including a front allowing viewing within the combustion chamber, one or more back panels opposite the front, a plurality of side panels, and a bottom panel, and wherein at least one of the one or more back panels and plurality of side panels includes a plurality of optically transmissive windows; and
providing a second enclosure including a plurality of panels secured together around the first enclosure; and
projecting light onto portions of the second enclosure that face the first enclosure to passively illuminate the combustion chamber through the plurality of optically transmissive windows.

19. The method of claim 16, and further comprising:
coating portions of the second enclosure panels facing the first enclosure with a reflective coating.

20. The method of claim 16, wherein projecting light onto the outer enclosure comprises:
projecting light upwardly from proximate the bottom panel and between the first enclosure and the second enclosure.

21. The method of claim 16, and further comprising:
varying at least one of a color and intensity of the light projected onto the second enclosure in response to an input.
